(19) United States
(12) Patent Application Publication
(10) Pub. No.: US 2010/0241453 A1
(43) Pub. Date: Sep. 23, 2010

(54) Method, Apparatus And Computer Program Product For Displaying And Permitting Revision Of A Potential Interaction

(75) Inventor: Arien Malec, Oakland, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: McKesson Financial Holdings Limited, Hamilton (BM)

(21) Appl. No.: 12/408,094

(22) Filed: Mar. 20, 2009

(51) Int. Cl. G06Q 50/00

(52) U.S. Cl. 705/3; 705/2

(57) ABSTRACT

A method, apparatus and computer program product are provided for displaying and permitting revision of a potential interaction with a medication under consideration for prescription to a patient. Initially, one or more potential interactions may be identified between a medication and one or more of a different medication, an allergy or a patient condition. The potential interactions may then be displayed with an indication of the type of potential interaction and the severity of the potential interaction. An input mechanism may be provided that is associated with the display of each potential interaction and that is configured to receive user input indicative of a change in one or more of the different medication, the allergy or the patient condition. Based upon this change, the potential interactions may be revised.

### FIELD OF THE INVENTION

Embodiments of the present invention relate generally to techniques for prescribing medication and, more particularly, to techniques for displaying and permitting revision of a potential interaction with a medication under consideration for prescription to a patient.

### BACKGROUND OF THE INVENTION

Various medications may be prescribed to a patient by a physician or other clinician. However, medications may have an unintended adverse impact upon a patient depending upon the interaction of the medication under consideration for prescription to a patient with other medications that are being taken by the patient, with allergies of the patient and/or with other patient conditions, such as the sex, race or gender of the patient or other medically relevant conditions such as obesity, diabetes, etc. In order to avoid complications that may arise due to these interactions, or at least to be aware of the potential interactions in advance of their occurrence such that the patient and the clinician may be appropriately forewarned, it is generally useful to know of potential interactions that may arise as a result of the prescription of a medication to the patient.

The number and variety of potential interactions makes manual identification of all potential interactions quite difficult. As such, electronic systems including, for example, computer applications, have been developed in order to identify potential interactions with respect to a medication that is under consideration for prescription to a patient. Such computer applications generally flag a potential interaction with the clinician being left to ascertain the relevance of the potential interaction since clinicians may not desire to respond in the same fashion to all potential interactions. For example, a clinician may wish to respond to a potential interaction between two medications differently than the clinician would respond to an interaction between a medication and an allergy or other patient condition. Further, the clinical significance of the various potential interactions may vary, thereby further evidencing that a clinician may wish to treat the various potential interactions in different manners. However, computer applications for identifying potential interactions do not generally provide information regarding the type of interaction and/or the clinical significance of a potential interaction in a summary form that is readily available to a clinician. Instead, a clinician may be required to analyze the generally voluminous data that underlies the computer application's identification of one or more potential interactions and to determine from the voluminous data the type of interaction and/or the clinical significance of the potential interaction. This analysis of the underlying data may be relatively extensive and, as such, may dissuade at least some clinicians from attempting to determine further information regarding a potential interaction and, instead, to simply select another medication for prescription to the patient in order to avoid the potential interaction that was previously identified.

In some instances, the underlying data that is analyzed by the computer application to identify one or more potential interactions may be outdated or otherwise incorrect. In this regard, a computer application configured to identify potential interactions with a medication that may be prescribed to a patient may access the patient's record to determine the medications that the patient currently takes, as well as any allergies or other medically relevant conditions of the patient. The computer application may then identify any potential interactions that exist between the medication that may be prescribed to the patient and the patient's other medications, allergies and/or other medically relevant conditions. In some instances, the information accessed by the computer application relating to the patient's other medications, allergies and/or medically relevant conditions may be outdated or otherwise incorrect. As noted above, however, it may be difficult or at least laborious for a clinician to locate and review the data, such as the patient's prior medications, allergies or other medically relevant conditions, that is relied upon by the computer application in order to identify potential interactions. Moreover, in the instance in which the underlying patient data is outdated or otherwise incorrect, it may also be difficult or at least laborious to attempt to correct the patient data to obtain a more accurate reflection of any potential interactions.

As such, it would be desirable to provide an improved technique for identifying potential interactions with a medication under consideration for prescription to a patient. In this regard, it would be desirable to provide an improved technique for identifying potential interactions with a medication under consideration for prescription to a patient with sufficient information for a clinician to readily determine the clinical significance of any potential interaction and to facilitate correction of any outdated or otherwise incorrect patient data underlying the identification of potential interactions.

### SUMMARY OF THE INVENTION

A method, apparatus and computer program product are therefore provided according to embodiments of the present invention for displaying and permitting revision of a potential interaction with a medication under consideration for prescription to a patient. In this regard, an embodiment of the method, apparatus and computer program product not only indicates a potential interaction, but also indicates the type of potential interaction and the severity of the potential interaction such that the clinical significance of a potential interaction may be readily determined. Further, embodiments of the method, apparatus and computer program product may be particularly configured to permit changes in the underlying patient data, such as changes in other medications, allergies or other medically relevant conditions of the patient, to be entered such that the potential interactions may be appropriately revised.

According to one embodiment, a method of displaying and permitting revision of a potential interaction is provided. In this regard, the method includes identifying one or more potential interactions between a medication and one or more of a different medication, an allergy or a patient condition. The method may then display the potential interactions including an indication of the type of potential interaction and the severity of the potential interaction. As such, a clinician can readily determine information regarding a potential interaction including its type and its severity in order to correspondingly determine the clinical significance of the potential interaction. Along with the display of the potential interactions, the method may provide, via a processor, an input mechanism associated with the display of each potential interaction to receive user input indicative of a change in one or more of the different medication, the allergy or the patient condition. Based upon this change, the potential interactions may be revised. As such, the underlying patient data may be readily updated or otherwise corrected such that the potential interactions that have been identified may be correspondingly revised based upon any change in the underlying patient data.

In one embodiment, the provision of the input mechanism may include providing an input mechanism associated with the display of the potential interaction between the medication and the different medications with the input mechanism being configured, upon selection, to indicate that the different medication has been discontinued. The provision of the input mechanism may also alternatively include providing an input mechanism associated with the display of the potential interaction between the medication and the allergy with the input mechanism being configured, upon selection, to indicate that the allergy is no longer active. The provision of the input mechanism may also or alternatively include providing an input mechanism associated with the display of the potential interaction between the medication and the patient condition with the input mechanism being configured, upon selection, to indicate that the patient condition is no longer active.

In displaying the potential interactions in accordance with one embodiment, the method may separately display the potential interactions between the medication and one or more different medications, between the medication and one or more allergies and between the medication and one or more patient conditions. Further, the method of this embodiment may separately indicate the severity of each different type of potential interaction. In addition to displaying the potential interactions, the medication under consideration for prescription to the patient may also be displayed along with an associated input mechanism to receive user input indicative of a change in the medication, such as in response to one or more clinically significant potential interactions.

Prior to identifying potential interactions with a medication under consideration for prescription to patient, the method of one embodiment receives an identification of a patient and of the medication that is under consideration. Based upon the identification of the patient, the method of this embodiment may determine any different medication, allergy or other patient condition associated with the patient such that any potential interactions may thereafter be identified.

An apparatus and a computer program product are also provided according to other embodiments of the present invention for displaying and permitting revision of a potential interaction. In this regard, the apparatus may include a processor configured to identify one or more potential interactions, provide for a display of the potential interactions including indications of the type and severity of the potential interactions, provide an input mechanism associated with the display of each potential interaction to receive user input indicative of a change in the underlying patient data, and revise the potential interactions based upon the change in the underlying patient data. In another embodiment, a computer program product is provided for displaying and permitting revision of a potential interaction with the computer program product. The computer program product includes at least one computer-readable storage medium having computer-executable program instructions stored therein. The computer-executable program instructions include program instructions configured to identify one or more potential interactions, program instructions configured to provide for a display of the potential interactions including indications of the type and severity of the potential interaction, program instructions configured to provide an input mechanism associated with a display of each potential interaction to receive user input indicative of a change in the underlying patient data and program instructions configured to revise the potential interaction based upon the change in the underlying patient data.

### BRIEF DESCRIPTION OF THE DRAWINGS

Having thus described the invention in general terms, reference will now be made to the accompanying drawings, which are not necessarily drawn to scale, and wherein:

FIG. 1 is a schematic representation of a computing system in accordance with one embodiment of the present invention;

FIG. 2 is a flow chart illustrating operations performed in accordance with one embodiment of the present invention;

FIG. 3 depicts a user interface configured to identify potential interactions with a medication under consideration for prescription to a patient in accordance with one embodiment of the present invention;

FIG. 4 depicts a user interface configured to provide additional information regarding a potential interaction between medications in accordance with one embodiment of the present invention;

FIG. 5 depicts a user interface comparable to that depicted in FIG. 4 following a change in the medication of the patient and the corresponding change in the potential interactions with the medication that is under consideration for prescription to the patient, in accordance with one embodiment of the present invention;

FIG. 6 depicts a user interface configured to provide more information regarding a potential interaction between medications as well as more information regarding potentially duplicative medications in accordance with one embodiment of the present invention;

FIG. 7 depicts a user interface configured to provide more information regarding a potential interaction between a medication and an allergy in accordance with one embodiment of the present invention; and

FIG. 8 depicts a user interface configured to provide additional information regarding a potential interaction between a medication and a patient condition in accordance with one embodiment of the present invention.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Embodiments of the present invention relate generally to a method, apparatus and computer program product for displaying and permitting revision of a potential interaction between a medication under consideration for prescription to a patient (referenced herein as the “medication under consideration”) and a different medication, an allergy and/or a patient condition. In this regard, potential interactions may exist between two or more drugs, one being the medication under consideration and the other having been previously prescribed to or is otherwise being taken by the patient. Additionally, potential interactions may exist between a medication under consideration and an allergy of the patient, such as an allergy to penicillin or the like. Still further, potential interactions may exist between a medication under consideration and one or more conditions of the patient, such as the patient's age, race, or gender, as well as medically relevant conditions, such as obesity, diabetes or other prior and ongoing medical conditions.

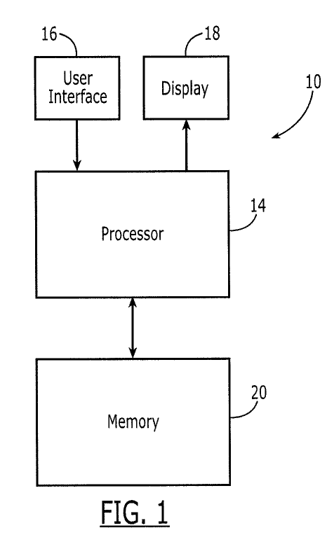

In accordance with one embodiment, the display and permissive revision of potential interactions is implemented by means of a computing device 10. The computing device may be implemented in various fashions including a dedicated processor, a personal computer, a workstation or any other type of appropriately configured processor. For purposes of example, however, the computing device in one embodiment is depicted in FIG. 1. As shown, the computing device may include a processor 14, a user interface 16, a display 18 and a memory device 20. The memory device may be configured to store information, data, applications, instructions or the like for enabling the computing device to carry out various functions in accordance with exemplary embodiments of the present invention. For example, the memory device may be configured to store a patient's health record as well as information defining the potential interactions associated with each of a number of different medications, as described below. Additionally or alternatively, the memory device may be configured to store instructions for execution by the processor.

The processor 14 may be embodied in a number of different ways. For example, the processor may be embodied as a processing element, a coprocessor, a controller or various other processing means or devices including integrated circuits such as, for example, an ASIC (application specific integrated circuit) or FPGA (field-programmable gate array) or combinations thereof. In an exemplary embodiment, the processor may be specifically configured to execute instructions stored in the memory device 20 or otherwise accessible to the processor. As such, whether configured by hardware or software methods, or by a combination thereof, the processor may represent an entity capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions specifically configure the processor to perform the algorithms and operations described herein.

The user interface 16 may be in communication with the processor 14 to receive an indication of a user input at the user interface and/or to provide an audible, visual, mechanical or other output to the user. As such, the user interface may include, for example, a keyboard, a mouse, a joystick, a trackball, a microphone, a speaker, or other input/output mechanisms. As noted above, the computing device 10 may also include a display 18 to present information to a user and, in some embodiments, to serve as a graphical user interface via which user input is provided to the computing device, such that the display may also comprise at least a portion of the user interface.

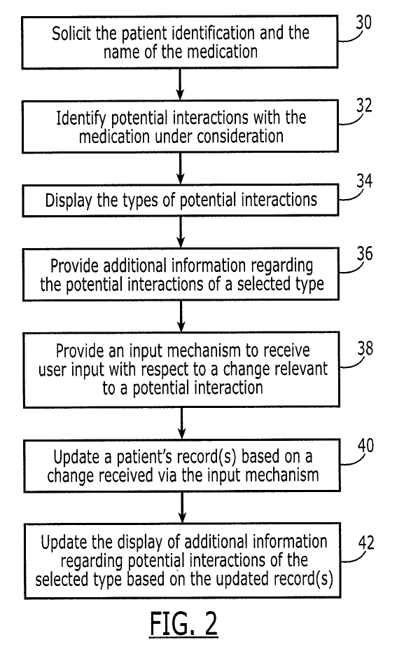

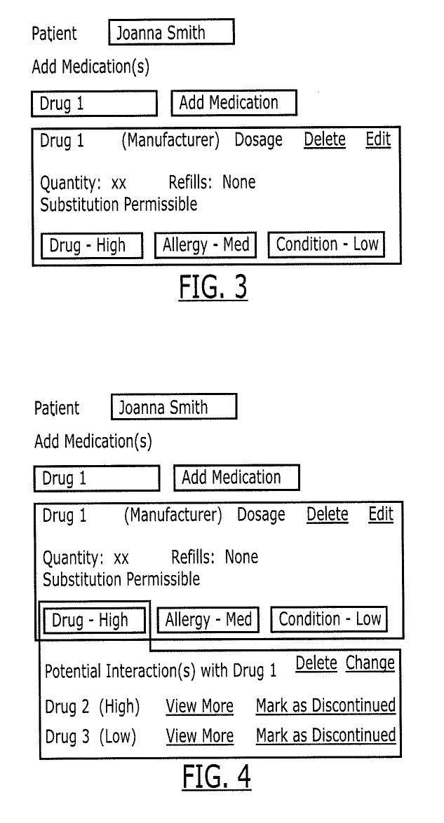

In operation, the processor 14 may configure the display 18 to serve as a graphical user interface via which a user can provide input and via which information regarding a potential interaction may be presented. As indicated by operation 30 of FIG. 2 and as shown in the display of FIG. 3, the processor can initially direct the display to present a graphical user interface via which a clinician or other user can identify a patient, such as by means of name, identification number or the like, and can identify a medication, e.g., Drug 1, that is under consideration for prescription to the patient. In response to the identification of the patient and the medication, the processor may analyze the data associated with the patient and determine any potential interaction with the medication under consideration. In this regard, the patient data may be stored in the memory device 20 or otherwise be accessible to the processor from external databases or the like and may include data identifying other medications prescribed to or otherwise taken by the patient, allergies of the patient and/or any other medically relevant patient conditions. Additionally, for each of a plurality of different medications that may be prescribed to a patient, the memory device or other database may include a listing of the other medications, allergies or patient conditions that may create a potential interaction with the respective medication as well as the severity of the potential interaction. As such, the processor can compare the patient data with the listing of other medications, allergies or patient conditions that may create a potential interaction with the medication under consideration. If the processor determines that the patient data indicates that the patient is currently prescribed or is otherwise taking another medication or has an allergy or another medically relevant condition that may cause a potential interaction with the medication that is under consideration, the processor can identify the particular medication, allergy and/or patient condition that creates the potential interaction with the medication under consideration along with the severity of the potential interaction. See operation 32 of FIG. 2.

As shown in operation 34 of FIG. 2 and as also reflected in the graphical user interface of FIG. 3, the processor 14 is configured to direct the display 18 to present a graphical user interface that displays the potential interactions with the medication under consideration. In addition to merely displaying the potential interactions, the processor is configured to direct the display to provide a graphical user interface that includes an indication of the type of potential interactions and the severity of the potential interactions. While various types of interactions may be defined, the illustrated embodiment of the present invention is configured to identify three different types of potential interactions, that is, interactions between the medication under consideration and a different medication that has been previously prescribed to the patient or which the patient is otherwise taking, interactions between the medication under consideration and allergies of the patient and interactions between the medication under consideration and a medically relevant condition of the patient. Each of these three types of potential interactions is represented by a respective selection element, e.g., a tab or button, of the graphical user interface.

In instances in which the processor 14 does not determine any potential interactions of a respective type, the selection element representative of the respective type of potential interaction may still be displayed, albeit with an indication, e.g., not applicable (N/A), that no potential interactions of the respective type have been identified. However, in instances in which the processor does identify a potential interaction of a respective type, the selection element of the respective type is displayed along with an indication of the severity of the potential interaction. While the severity may be indicated in various manners, the severity of each different type of potential interaction may be indicated as either low, medium (med) or high and, in one embodiment, the respective selection elements may be labeled and appropriately color-coded, shaded or otherwise depicted in a manner representative and unique to the severity of the respective type of potential interaction.

In instances in which several potential interactions of the same type are identified relative to the medication in question, the processor 14 may define the severity of the respective type of potential interaction to be equal to the most severe of the potential interactions of the respective type. For example, if three potential interactions of a respective type were identified relative to the medication under consideration with a first one of the potential interactions having a low severity, a second one of the potential interactions having a medium severity and a third one of the potential interactions having a high severity, the severity associated with the selection element representative of the respective type of potential interaction may be defined to be high, that is, equal to the most severe of the potential interactions of the respective type.

In order to obtain further information regarding the different types of potential interactions, a user can actuate the selection element representative of the respective type of potential interaction. As shown in FIG. 4, in response to the selection of the “drug” selection element, the processor 14 may direct the display 18 to present a graphical user interface providing additional information regarding the drugs that the patient has been previously prescribed or is otherwise taking that create a potential interaction with the medication under consideration. See operation 36 of FIG. 2. While any number of different drugs may be listed, the graphical user interface of FIG. 4 illustrates drugs previously prescribed to the patient that may create potential interactions, that is, Drug 2 and Drug 3. The severity of the potential interaction is also illustrated, e.g., high with respect to Drug 2 and low with respect to Drug 3, as well as links or other input mechanisms, e.g., the “View More” link, associated with respective ones of the other drugs for obtaining additional information regarding the other drugs.

In accordance with embodiments of the present invention, the processor 14 may direct the display 18 to present a graphical user interface having an input mechanism associated with the display of each potential interaction to receive user input indicative of a change relevant to the potential interaction. See operation 38 of FIG. 2. While various input mechanisms may be employed, the user interface of FIG. 4 includes a link designated “Mark as Discontinued” associated with each respective drug with which the medication under consideration has a potential interaction. In instances in which a drug that has a potential interaction with the medication under consideration has previously been discontinued by the patient or is no longer going to be taken by the patient, a user, such as a clinician, can actuate the input mechanism, such as by clicking the respective link, to advise the processor that the associated medication is no longer being taken by the patient such that the processor can, in turn, update the patient's records. See operation 40.

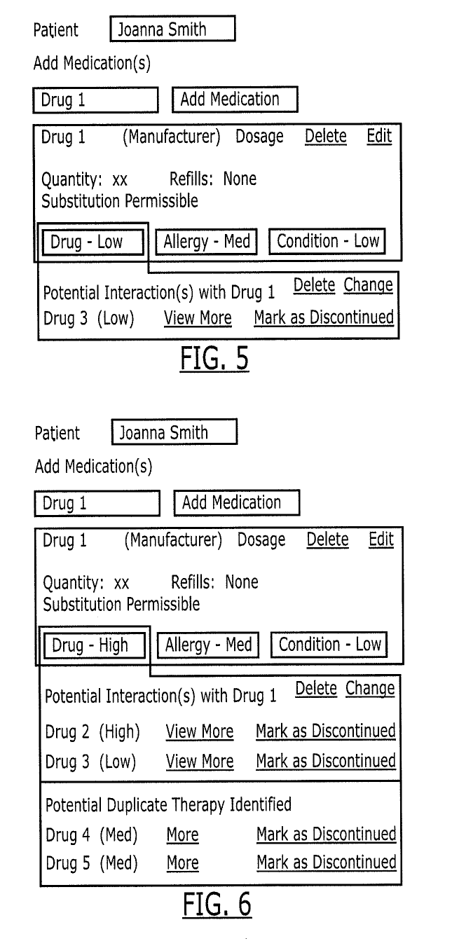

Based upon this change, the processor 14 can then again determine the potential interactions that may occur in response to the medication under consideration. As shown in FIG. 5, following the selection of the link designated “Mark as Discontinued” associated with Drug 2, the processor can then direct the display 18 to present a graphical user interface that has been updated with at least the medication that was inactivated, e.g., Drug 2, being removed relative to the display depicted in FIG. 4. See operation 42 of FIG. 2. Since the only remaining drug, e.g., Drug 3, that is prescribed to or taken by the patient that may create a potential interaction with the medication under consideration is of a low severity level, the severity level associated with the drug selection element of FIG. 5 is therefore also changed from high as shown in FIG. 4 to low as shown in FIG. 5. As shown in the foregoing example, a user, such as a clinician, can therefore quickly and easily update a patient's health record in order to determine a reliable and up-to-date set of potential interactions that are not cluttered with potential interactions triggered by potentially outdated patient data.

In addition to or instead of discontinuing one or more of the other medications in order to avoid a potential interaction with the medication under consideration, the medication under consideration may be changed, either by changing the medication itself or by changing its dosage, form of administration or the like in an effort to address the potential interactions. As shown in FIGS. 3-5, for example, the graphical user interface can include selection elements to delete the medication under consideration and/or to edit the medication under consideration, such as by changing the dosage of the medication under consideration. In FIGS. 3-5, the selection element configured to delete the medication under consideration is represented by the actuable link designated “Delete” and the selection element configured to edit the medication under consideration is represented by the actuable link designated “Edit”.

The processor 14 may also direct the display 18 to present a graphical user interface having a variety of additional or different information depending upon the preferences of, for example, the clinician. As shown in FIG. 6, for example, the processor may direct the display to present a user interface that not only includes information regarding the type of severity of potential interactions, but also a listing of one or more medications or other therapies that have been previously prescribed or otherwise taken by the patient, but provide potentially duplicative therapy with respect to the medication under consideration. Armed with this information, a user, such as a clinician, can therefore determine whether to continue to prescribe all of the various medications or whether one or more of the medications should be discontinued, such as by selecting the “Mark as Discontinued” link associated with a respective medication.

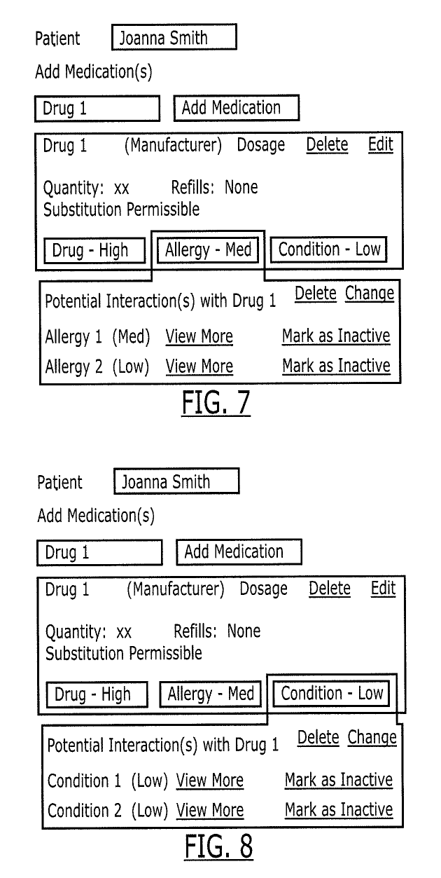

As illustrated above in FIGS. 3-6 with respect to potential interactions between drugs, the processor 14 can direct the display 18 to provide a graphical user interface that is capable of providing comparable information regarding the other types of potential interactions, such as potential interactions between the medication under consideration and the patient's allergies and/or between the medication under consideration and any medically relevant patient conditions. As shown in FIG. 7, for example, in response to the user's activation of the selection element associated with potential interactions attributable to the patient's allergy, the processor may present a graphical user interface that provides additional information regarding each allergy that creates a potential interaction as well as the severity of the potential interaction. The graphical user interface may also include an input mechanism associated with each allergy that creates a potential interaction. As before, the input mechanism may be any of a variety of different mechanisms including a link as shown in the illustrated embodiment and as designated “Mark as Inactive”. Upon actuation of the input mechanism, such as selection of the link, a user is able to indicate that the respective allergy is no longer active. The processor may receive this change, update the patient's health record and then determine what, if any, potential interactions remain for the patient that is prescribed the medication under consideration.

Similarly, as shown in FIG. 8, in response to the user's activation of the selection element associated with potential interactions attributable to the patient's conditions, the processor may present a graphical user interface that provides additional information regarding each condition that creates a potential interaction as well as the severity of the potential interaction. The graphical user interface may also include an input mechanism associated with each condition that creates a potential interaction. As before, the input mechanism may be any of a variety of different mechanisms including a link as shown in the illustrated embodiment and as designated “Mark as Inactive”. Upon actuation of the input mechanism, such as selection of the link, a user is able to indicate that the respective condition is no longer active. The processor may receive this change, update the patient's health record and then determine what, if any, potential interactions remain for the patient that is prescribed the medication under consideration.

As such, a user, such as a clinician, is able to readily and intuitively update a patient's record such that the data upon which the processor 14 relies to determine the potential interaction is current and accurate and the resulting potential interactions are therefore reliable and of a high quality. Moreover, embodiments of the method, apparatus and computer program product of the present invention permit the patient data that was relied upon by the processor to identify one or more potential interactions, to be updated or otherwise changed in a straightforward manner, such as by means of a single click in one embodiment.

FIG. 2 is a flowchart of a system, method and program product according to exemplary embodiments of the invention. It will be understood that each block or step of the flowchart, and combinations of blocks in the flowchart, can be implemented by various means, such as hardware, firmware, and/or a computer program product including one or more computer program instructions. For example, one or more of the procedures described above may be embodied by computer program instructions. In this regard, the computer program instructions which embody the procedures described above may be stored by the memory device 20 and executed by the processor 14. As will be appreciated, any such computer program instructions may be loaded onto a computer or other programmable apparatus (i.e., hardware) to produce a machine, such that the computer program product including the instructions which execute on the computer or other programmable apparatus creates means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of displaying and permitting revision of a potential interaction, the method comprising:
identifying one or more potential interactions between a medication and one or more of a different medication, an allergy or a patient condition;
displaying the potential interactions including an indication of a type of potential interaction and a severity of the potential interaction;
providing, via a processor, an input mechanism associated with a display of each potential interaction to receive user input indicative of a change in one or more of the different medication, the allergy or the patient condition; and
revising the potential interactions based upon the change in one or more of the different medication, the allergy or the patient condition.

2. A method according to claim 1 wherein providing the input mechanism comprises providing an input mechanism associated with the display of the potential interaction between the medication and the different medication and configured, upon selection, to indicate that the different medication has been discontinued.

3. A method according to claim 1 wherein providing the input mechanism comprises providing an input mechanism associated with the display of the potential interaction between the medication and the allergy and configured, upon selection, to indicate that the allergy is no longer active.

4. A method according to claim 1 wherein providing the input mechanism comprises providing an input mechanism associated with the display of the potential interaction between the medication and the patient condition and configured, upon selection, to indicate that the patient condition is no longer active.

5. A method according to claim 1 further comprising providing an input mechanism associated with a display of the medication to receive user input indicative of a change in the medication.

6. A method according to claim 1 wherein displaying the potential interactions comprises separately displaying the potential interactions between the medication and one or more different medications, between the medication and one or more allergies and between the medication and one or more patient conditions and separately indicating the severity of each different type of potential interaction.

7. A method according to claim 1 further comprising:
receiving an identification of a patient and of the medication; and
based upon the identification of the patient, determining any different medication, allergy or patient condition associated with the patient prior to identifying one or more potential interactions.

8. An apparatus for displaying and permitting revision of a potential interaction, the apparatus comprising a processor configured to:
identify one or more potential interactions between a medication and one or more of a different medication, an allergy or a patient condition;
provide for a display of the potential interactions including an indication of a type of potential interaction and a severity of the potential interaction;
provide an input mechanism associated with the display of each potential interaction to receive user input indicative of a change in one or more of the different medication, the allergy or the patient condition; and
revise the potential interactions based upon the change in one or more of the different medication, the allergy or the patient condition.

9. An apparatus according to claim 8 wherein the processor is configured to provide the input mechanism by providing an input mechanism associated with the display of the potential interaction between the medication and the different medication and configured, upon selection, to indicate that the different medication has been discontinued.

10. An apparatus according to claim 8 wherein the processor is configured to provide the input mechanism by providing an input mechanism associated with the display of the potential interaction between the medication and the allergy and configured, upon selection, to indicate that the allergy is no longer active.

11. An apparatus according to claim 8 wherein the processor is configured to provide the input mechanism by providing an input mechanism associated with the display of the potential interaction between the medication and the patient condition and configured, upon selection, to indicate that the patient condition is no longer active.

12. An apparatus according to claim 8 wherein the processor is further configured to provide an input mechanism associated with a display of the medication to receive user input indicative of a change in the medication.

13. An apparatus according to claim 8 wherein the processor is configured to provide for the display of the potential interactions by providing for the separate display of the potential interactions between the medication and one or more different medications, between the medication and one or more allergies and between the medication and one or more patient conditions and by separately indicating the severity of each different type of potential interaction.

14. An apparatus according to claim 8 wherein the processor is further configured to:
receive an identification of a patient and of the medication; and
based upon the identification of the patient, determine any different medication, allergy or patient condition associated with the patient prior to identifying one or more potential interactions.

15. A computer program product for displaying and permitting revision of a potential interaction, wherein the computer program product comprises at least one computer-readable storage medium having computer-executable program instructions stored therein, the computer-executable program instructions comprising:
program instructions configured to identify one or more potential interactions between a medication and one or more of a different medication, an allergy or a patient condition;
program instructions configured to provide for a display of the potential interactions including an indication of a type of potential interaction and a severity of the potential interaction;
program instructions configured to provide an input mechanism associated with a display of each potential interaction to receive user input indicative of a change in one or more of the different medication, the allergy or the patient condition; and
program instructions configured to revise the potential interactions based upon the change in one or more of the different medication, the allergy or the patient condition.

16. A computer program product according to claim 15 wherein the program instructions configured to provide the input mechanism comprise program instructions configured to provide an input mechanism associated with the display of the potential interaction between the medication and the different medication and configured, upon selection, to indicate that the different medication has been discontinued.

17. A computer program product according to claim 15 wherein the program instructions configured to provide the input mechanism comprise program instructions configured to provide an input mechanism associated with the display of the potential interaction between the medication and at least one of the allergy or the patient condition and configured, upon selection, to indicate that the respective one of the allergy or the patient condition is no longer active.

18. A computer program product according to claim 15 wherein the computer-executable program instructions further comprise program instructions configured to provide an input mechanism associated with a display of the medication to receive user input indicative of a change in the medication.

19. A computer program product according to claim 15 wherein the program instructions configured to provide for the display of the potential interactions comprises program instructions configured to provide for a separate display of the potential interactions between the medication and one or more different medications, between the medication and one or more allergies and between the medication and one or more patient conditions and to provide for a separate indication of the severity of each different type of potential interaction.

20. A computer program product according to claim 15 wherein the computer-executable program instructions further comprise:
program instructions configured to receive an identification of a patient and of the medication; and
based upon the identification of the patient, program instructions configured to determine any different medication, allergy or patient condition associated with the patient prior to identifying one or more potential interactions.
